(19) United States
(12) Patent Application Publication
(10) Pub. No.: US 2017/0018163 A1
(43) Pub. Date: Jan. 19, 2017

(54) METHOD FOR TRIGGERING OF THE EMERGENCY RESPONDING SYSTEM BY USING HUMAN SCREAM

(71) Applicant: Wen Pu, Beijing (CN)

(72) Inventor: Wen Pu, Beijing (CN)

(21) Appl. No.: 14/944,268

(22) Filed: Nov. 18, 2015

(30) Foreign Application Priority Data
Jul. 16, 2015 (CN) 201510416777.0

(51) Int. Cl. G08B 21/04

(52) U.S. Cl. CPC G08B 21/0469

(57) ABSTRACT

The present invention discloses a method for triggering of emergency responding system by using human scream. The method comprises of the following steps:
step one: a voice sensor senses human scream, simultaneously converts the scream into electrical signal and transmits the signal to a voice identification module through signal cable;
step two: the voice identification module automatically identifies the signal in accordance with the audio frequency, intensity, and time features that are stored and programmed as the audio-feature library, and if the signal is identified as an emergency happening, it will to be transmitted to the control circuit;
step three: the emergency responding system receives the emergency signal from a control circuit, and triggers an alarm and the emergency responding functionalities via the preset program. The wireless communication network modules or telecommunication network modules transmits the alarm and emergency signal to the corresponding party or system wirelessly and remotely;
step four; when receiving the alarm and emergency notification, the first-aid crew or corresponding staff take actions following emergency responding process.

With this method, the corresponding party i.e. first-aid crew, police, security force etc. can notice the emergency happening and location as soon as the scream is sensed and identified, therefore the action can be taken sooner and more effectively.

### CROSS-REFERENCE TO RELATED APPLICATIONS

This application is a continuation in part of, and claims priority to, Chinese Patent Application No. 201510416777.0 with a filing date of Jul. 16, 2015. The content of the aforementioned application, including any intervening amendments thereto, is incorporated herein by reference.

### TECHNICAL FIELD

The present invention belongs to the field of security & emergency responding systems and methods, in particular to a method for triggering of an emergency responding system by using human scream.

### BACKGROUND OF THE PRESENT INVENTION

The existing technology for triggering of emergency responding system mostly is relies on pressing an emergency button to trigger alarm, but in many emergency conditions, such as elevator fall, gangster attack in elevator, bank or forbidden area robbery, etc., people can hardly get chance to press emergency button. For example, a well-known advice to carry out self-help if experiencing elevator falls is, that try to press floor buttons as many as possible to win a chance that the elevator could stop falling. But it is almost impossible for scared people to make it during the short time of free fall.

When experiencing bank robbery, the gangsters have weapons to threaten people not to call the police or make any move, so people can hardly take any action to get help.

When an airliner faces a fatal problem to fall and finally crash, it is not often but sure happens sometimes that, the crash place and debris cannot be found soon, e.g. MH370. Therefore, the chance of saving lives is cut to be zero, and the expenses spent on finding the missing plane is huge.

The cases above are different, but there is a common fact that, whichever emergency occurs, the people in the situation might always scream, and scream is conditioned reflex by nature at zero cost.

### SUMMARY OF THE PRESENT INVENTION

To address the defect in the prior art that it is almost impossible for the scared s people in danger to press emergency button when emergency occurs, the present invention provides a method for triggering of an emergency responding system by using human scream. The scream can be used as a signal for triggering of the emergency responding system of an elevator, or a building security system, or an airliner emergency notification system.

The specific technical solution adopted by the present invention is that:

A method for triggering of an emergency responding system by using human scream. The emergency responding system externally comprises of a voice sensor, a voice identification module, a control circuit, an alarm device, a wireless network or telecommunication network transmission module and a receiving module, wherein the control circuit, the alarm device and the wireless network or telecommunication network transmission module are electrically connected with the emergency responding system respectively; the voice identification module is electrically connected with the control circuit and the voice sensor respectively; and the wireless network or the telecommunication network transmission module is connected with the receiving module.

The emergency responding system internally comprises of a central processing chip, a voice processing module, a circuit control command module, a power supply module, a storage module, an alarm module, a video processing module, a wireless receiving module and a telecommunication module/GPS positioning module, wherein the voice processing module, the circuit control command module, the power supply module, the storage module, the alarm module, the video processing module, the wireless receiving module and the telecommunication module/GPS positioning module are respectively connected with the central processing chip.

The method comprises of the following steps:

Step one: a voice sensor senses human scream, simultaneously converts the scream into electrical signal and transmits the signal to a voice identification module through signal cable;

Step two: the voice identification module automatically identifies the signal in accordance with the audio frequency, intensity, and time features that are stored and programmed as audio-feature library, and if the signal is identified as an emergency happening, it will be transmitted to the control circuit;

Step three: the emergency responding system receives the emergency signal from a control circuit, and triggers an alarm and the emergency responding functionalities via the preset program. The wireless communication network modules or telecommunication network modules transmits the alarm and emergency signal to the corresponding party or system wirelessly and remotely;

Step four: when receiving the alarm and emergency notification, the first-aid crew or corresponding staff take actions following emergency responding process.

Further, the voice identification module comprises of a storage module used for storing the audio-feature library of the scream; and after matching and identifying the received electrical signal in the audio-feature library of the scream, and the signal is identified as an emergency happening, the voice identification module outputs an alarm signal to the control circuit.

Further, the emergency responding system is also connected with a display and a video camera; the signal input ports of the display and the video camera are connected with the emergency responding system; and the display and the video camera are used for displaying or recording, the site conditions where the scream occurs.

Further, the receiving module comprises of a telecommunication network transmission module or GPS positioning module that is used for positioning the location of scream.

Further, the method is used for emergency response of elevator, security measures of building, or emergency responding and rescue measure of civil aviation.

Further, the audio-feature library of the scream comprises of scream voice features range in different ages, different sex and different quantity of people.

The present invention brings the benefits that:

First, by adopting the human scream to trigger of the emergency responding system, the elevator emergency response can automatically switch on all the floor buttons, trigger emergency stop, or dial-in security intercom to set up dialogue with service crew; Second, the alarm system of the building security system (e.g. bank counter or forbidden area) can be automatically triggered by the scream remotely instead of taking risk to press the button;

Third, the emergency notification system of airliner is triggered by the scream, and automatically sends alarm, condition and location of scream to the corresponding crew on the ground. If the plane finally crashed, the notification information would be helpful to locate the crash place and debris soon, and first-aid crew would win more time to save lives.

### BRIEF DESCRIPTION OF THE DRAWINGS

FIG. 1: Block diagram of a structure of an emergency responding system of the present invention.

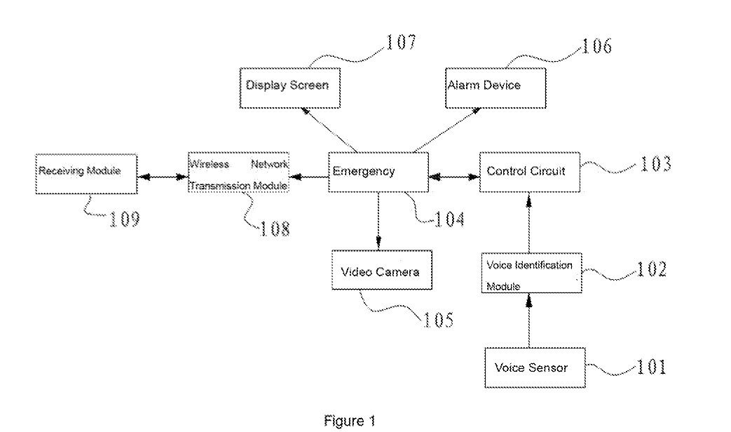

FIG. 2: Block diagram of architecture within the emergency responding system of the present invention.

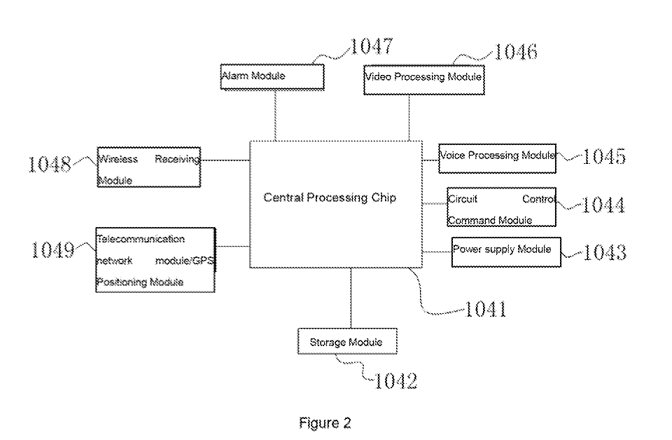

FIG. 3: Flow diagram of a method for triggering of an emergency responding system by using human scream in the present invention.

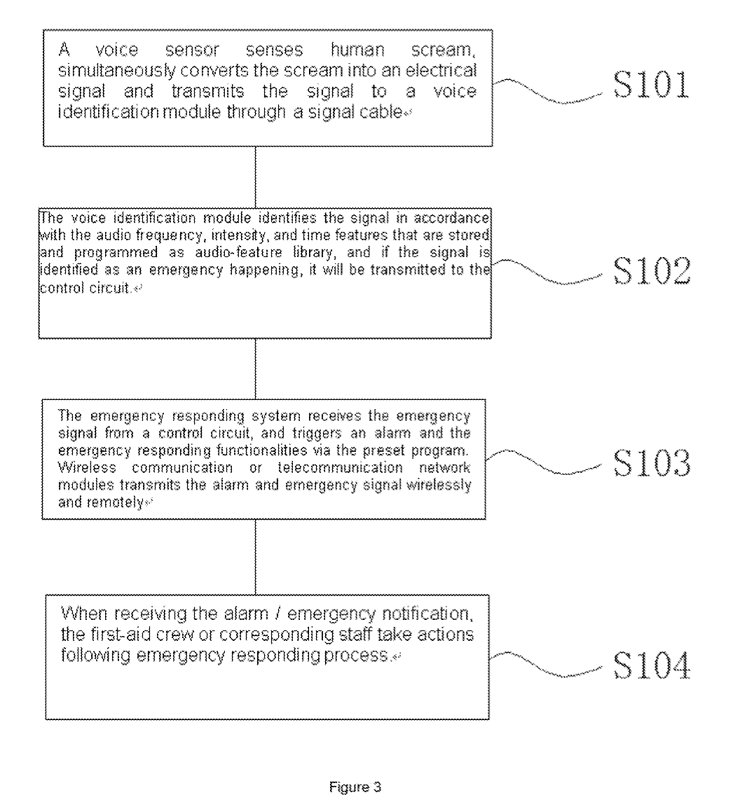

### DETAILED DESCRIPTION OF THE PRESENT INVENTION

For more clarity and explicitness of the purposes, the technical solution and the advantages of the present invention, the present invention is further described in detail below with the combination of embodiments. It should be understood that the specific embodiments described herein are used to explain the present invention ONLY having no limitation to the present invention.

The most common conditioned reflex action when people get scared is screaming, and scream is conditioned reflex by nature at zero cost.

### Embodiment 1

In elevator, the emergency responding system automatically switches on all the floor buttons, triggers emergency stop, dials in security intercom to set up dialogue with service crew. The specific embodiment is as follows:

A method for triggering of an emergency responding system by using human scream. The emergency responding system 104 externally comprises of a voice sensor 101, a voice identification module 102, a control circuit 103, an alarm device 106, a wireless network or telecommunication network transmission module 108 and a receiving module 109, wherein the control circuit 103, the alarm device 106 and the wireless network or telecommunication network transmission module 108 are electrically connected with the emergency responding system 104 respectively; the voice identification module 102 is electrically connected with the control circuit 103 and the voice sensor 101 respectively; and the wireless network or telecommunication network transmission module 108 is connected with the receiving module 109.

The emergency responding system 104 internally comprises of a central processing chip 1041, a voice processing module 1045, a circuit control command module 1044, a power supply module 1043, a storage module 1042, an alarm module 1047, a video processing module 1046, a wireless receiving module 1048 and a telecommunication/GPS positioning module 1049, wherein the voice processing module 1045, the circuit control command module 1044, the power supply module 1043, the storage module 1042, the alarm module 1047, the video processing module 1046, the wireless receiving module 1048 and the telecommunication module/GPS positioning module 1049 are respectively connected with the central processing chip 1041.

The method comprises of the following steps:

Step one S101: the voice sensor 101 senses human scream, simultaneously converts the scream into an electrical signal and transmits the signal to the voice identification module 102 through a signal cable;

Step two S102: the voice identification module 102 automatically identifies the signal in accordance with the audio frequency, intensity, and time features that are stored and programmed as audio-feature library, and if the signal is identified as an emergency happening, the signal will be transmitted to the control circuit 103;

Step three S103: the emergency responding system 104 receives the emergency signal from the control circuit 103, and the alarm module 1047 triggers an alarm and starts the alarm device 106, and the wireless receiving module 1048 and the wireless network or telecommunication network transmission module 108 transmit the alarm signal to the corresponding party or system wirelessly and remotely; and

Step four S104: receiving the alarm, the first-aid crew or corresponding staff take actions following emergency response process.

The voice identification module comprises of a storage module used for storing the audio-feature library of screams; and after matching and identifying the received electrical signal in the audio-feature library of the scream, the voice identification module outputs the signal to the control circuit.

The emergency responding system 104 is also connected with a display 107 and a video camera 105; the signal input ports of the display 107 and the video camera 105 are connected with the emergency responding system 104; the display 107 and the video camera 105 are used for displaying or recording the site conditions where the scream occurs.

The receiving module 109 comprises of a telephone intercom used for identifying the location of scream through the telephone intercom.

By adopting the method of the present invention, when the elevator fall gangster attack in the elevator occurs, the scream by the people in danger can automatically switch on all the floor buttons and emergency stop through voice control, simultaneously switch on the security intercom. On one hand, the chance of self-rescue can be increased; on the other hand, first-aid crew can be notified of the emergency happening sooner and take action earlier.

### Embodiment 2

In bank or forbidden area, the alarm system of the building security system can be automatically triggered by the scream. The specific embodiment is as follows:

A method for triggering of an emergency responding system by using human scream. The emergency responding system 104 externally comprises of a voice sensor 101, a voice identification module 102, a control circuit 103, an alarm device 106, a wireless network or telecommunication network transmission module 108 and a receiving module 109, wherein the control circuit 103, the alarm device 106 and the wireless network or telecommunication network transmission module 108 are electrically connected with the emergency response system 104 respectively; the voice identification module 102 is electrically connected with the control circuit 103 and the voice sensor 101 respectively: and the wireless network or telecommunication network transmission module 108 is connected with the receiving module 109.

The emergency responding system 104 internally comprises of a central processing chip 1041, a voice processing module 1045, a circuit control command module 1044, a power supply module 1043, a storage module 1042, an alarm module 1047, a video processing module 1046, a wireless receiving module 1048 and a telecommunication network module 1049, wherein the voice processing module 1045, the circuit control command module 1044, the power supply module 1043, the storage module 1042, the alarm module 1047, the video processing module 1046, the wireless receiving module 1048 and the telecommunication network module/GPS positioning module 1049 are respectively connected with the central processing chip 1041.

The method comprises the following steps:

Step one S101: the voice sensor 101 senses human scream, simultaneously converts the scream into an electrical signal and transmits the signal to the voice identification module 102 through a signal cable;

Step two S102: the voice identification module 102 identifies the transmitted electrical signalin accordance with the audio frequency, intensity, and time features that are stored and programmed as audio-feature library, and if the signal is identified as an emergency happening, it will be transmitted to the control circuit 103;

Step three S103: the emergency responding system 104 receives the emergency signal from the control circuit 103, the alarm module 1047 triggers an alarm and starts the alarm device 106, and the wireless receiving module 1048 and the wireless network transmission module 108 transmit the alarm signal to the corresponding party or system wirelessly and remotely;

Step four S104: When receiving the alarm, the first-aid crew or corresponding staff take actions following emergency response process.

The voice identification module comprises of a storage module used for storing the audio-feature library of the scream; and after matching and identifying the received electrical signal in the audio-feature library of the scream, the voice identification module outputs the signal to the control circuit.

The emergency responding system 104 is also connected with a display 107 and a video camera 105; the signal input ports of the display 107 and the video camera 105 is connected with the emergency response 104; and the display 107 and the video camera 105 are used for displaying or recording the site conditions where the scream occurs.

The receiving module 109 comprises of telecommunication network module/GPS positioning module that can transmit alarm and location to the corresponding partly wirelessly.

By adopting the method, when bank robbery or unauthorized people breaking into forbidden area, screams can switch on the built-in alarm functionality of the building security system through voice control, people do not need to take risk to press the alarm button when life is threatened, thereby alarm triggering can be quicker, safer and more humanized.

### Embodiment 3

On an airliner, the emergency notification system automatically sends alarm, conditions and location to the ground triggered by the scream. The specific embodiment is as follows:

A method for triggering of a emergency responding system by using human scream. The emergency responding system 104 externally comprises of a voice sensor 101, a voice identification module 102, a control circuit 103, an alarm device 106, a wireless network transmission module 108 and a receiving module 109, wherein the control circuit 103, the alarm device 106 and the wireless network transmission module 108 are electrically connected with the emergency responding system 104 respectively; the voice identification module 102 is electrically connected with the control circuit 103 and the voice sensor 101 respectively; and the wireless network transmission module 108 is connected with the receiving module 109.

The emergency responding system 104 internally comprises of a central processing chip 1041, a voice processing module 1045, a circuit control command module 1044, a power supply module 1043, a storage module 1042, an alarm module 1047, a video processing module 1046, a wireless receiving module 1048 and a telecommunication network module/GPS positioning module 1049, wherein the voice processing module 1045, the circuit control command module 1044, the power supply module 1043, the storage module 1042, the alarm module 1047, the video processing module 1046, the wireless receiving module 1048 and the telecommunication network module/GPS positioning module 1049 are respectively connected with the central processing chip 1041.

The method comprises the following steps:

Step one S101: the voice sensor 101 senses human scream, simultaneously converts the scream into an electrical signal and transmits the signal to the voice identification module 102 through a signal cable:

Step two S102: the voice identification module 102 identifies the transmitted electrical signal in accordance with the audio frequency, intensity, and time features that are stored and programmed as audio-feature library, and if the signal is identified as an emergency happening, then it will be transmitted to the control circuit 103;

Step three S103: the emergency responding system 104 receives the emergency signal, the alarm module 1047 triggers an alarm and starts the alarm device 106, and the wireless receiving module 1048 and the wireless network or telecommunication network transmission module 108 transmit the signal to the corresponding party or system wirelessly and remotely;

Step four S104: when receiving the alarm, the first-aid crew or corresponding staff take actions following emergency response process.

The voice identification module 102 comprises of a storage module 1042 used for storing the audio-feature library of the scream; and after matching and identifying the received electrical signal in the audio-feature library of the scream, the voice identification module 102 outputs the signal to the control circuit 103.

The emergency responding system 104 is also connected with a display 107 and a video camera 105; the signal input ports of the display 107 and the video camera 105 are connected with the emergency responding system 104; the display 107 and the video camera 105 are used for displaying or recording the site conditions where the scream occurs.

The receiving module 109 comprises of a telecommunication module or GPS positioning module used for positioning the location of screams.

The audio-feature library of the scream comprises of audio features range in different ages, different sex and different quantity of people.

The method is used as the emergency notification system of airliner. When the plane encounters fatal problem and fall, the passengers scream and it triggers the emergency notification system to automatically send alarm, condition and location of scream to the corresponding crew on the ground. If the plane finally crashed, the notification information would be helpful to locate the crash place and debris soon, and first-aid crew would win more time to save lives.

The present invention applies to supplementary functionalities for elevators, bank counters, forbidden areas in buildings etc., either brand new projects or existing ones, aiming to improve security level and increase effectiveness of security measures.

The purpose of above description is to present preferred embodiments of the present invention ONLY having no limitation to the present invention. Any modifications, equivalent replacements and improvements, etc., made within the spirit and the principle of the present invention should be contained within the protection scope of the present invention.

What is not described in the present invention is suitable for the prior art.

I claim:

1. A method for triggering of emergency responding system by using human scream, characterized in that: the emergency responding system externally comprises of a voice sensor, a voice identification module, a control circuit, an alarm device, a wireless network or telecommunication network transmission module and a receiving module, wherein the control circuit, the alarm device and the wireless network or telecommunication network transmission module are electrically connected with the emergency responding system respectively; the voice identification module is electrically connected with the control circuit and the voice sensor respectively; and the wireless network or telecommunication to network transmission module is connected with the receiving module;
The emergency responding system internally comprises of a central processing chip, a voice processing module, a circuit control command module, a power supply module, a storage module, an alarm module, a video processing module, a wireless receiving module and a telecommunication module/GPS positioning module, wherein the voice processing module, the circuit control command module, the power supply module, the storage module, the alarm module, the video processing module, the wireless receiving module and the telecommunication module/GPS positioning module are respectively connected with the central processing chip;
The method comprises of the following steps;
Step one: a voice sensor senses human scream, simultaneously converts the scream into electrical signal and transmits the signal to a voice identification module through signal cable;
Step two: the voice identification module automatically identifies the signal in accordance with the audio frequency, intensity, and time features that are stored and programmed as audio-feature library, and if the signal is identified as an emergency happening, it will be transmitted to the control circuit
Step three: the emergency responding system receives the emergency signal from a control circuit, and triggers an alarm and the emergency responding functionalities via the preset program. The wireless communication network modules or telecommunication network modules transmits the alarm and emergency signal to the corresponding party or system wirelessly and remotely;
Step four: when receiving the alarm and emergency notification, the first-aid crew or corresponding staff take actions following emergency response process.

2. The method for triggering of the emergency responding system according to claim 1, characterized in that: the voice identification module comprises of a storage module used for storing the audio-feature library of the scream; and after matching and identifying the received electrical signal in the audio-feature library, if the signal is identified as an emergency happening, the voice identification module outputs the signal as an alarm and emergency happening to the control circuit.

3. The method for triggering of the emergency responding system according to claim 1, characterized in that: the emergency responding system is also connected with a display and a video camera; the signal input ports of the display and the video camera are connected with the emergency responding system; and the display and the video camera are used for displaying and recording the site conditions where the scream occurs.

4. The method for triggering of the emergency responding system according to claim 1, characterized in that: the receiving module comprises of a telecommunication network transmission module or GPS positioning module used for positioning the location of scream.

5. The method for triggering of the emergency responding system according to claim 1, characterized in that: the method is used for emergency response of elevator, security measures of building, or emergency notification and response of civil aviation (airliner).

6. The method for triggering of the emergency responding system according to claim 1, characterized in that: the audio-feature library of the scream comprises of scream voice features range in different ages, different sex and different quantity of people.
